(19) United States
(12) Patent Application Publication
(10) Pub. No.: US 2011/0085160 A1
(43) Pub. Date: Apr. 14, 2011

(54) SPECTRAL DETECTOR WITH ANGULAR RESOLUTION USING REFRACTIVE AND REFLECTIVE STRUCTURES

(76) Inventors: Ties Van Bommel, Eindhoven (NL); Eduard Johannes Meijer, Eindhoven (NL); Rifat Ata Mustafa Hikmet, Eindhoven (NL)

(21) Appl. No.: 12/995,487

(22) PCT Filed: Jun. 9, 2009
(86) PCT No.: PCT/IB2009/052431

§ 371 Date: Dec. 1, 2010

(30) Foreign Application Priority Data
Jun. 16, 2008 (EP) 08104428.1

(51) Int. Cl. G01B 11/26

(52) U.S. Cl. 356/138

(57) ABSTRACT

A detector for receiving light impinging at a reception point and for measuring, for a plurality of angles of incidence, at least one property of the light. The detector includes a plurality of light sensors, each of which is associated with an acceptance interval (which defines the angle of incidence which a light beam must have to reach the light sensor) and at least two acceptance intervals are different from one another. The detector further includes an optical conductor for conducting a light beam from the reception point to a particular light sensor, but only if the angle of incidence of the light beam belongs to the acceptance interval associated with the particular light sensor.

The present invention relates to optical measurements. Particularly, the present invention relates to a direction-sensitive light detector.

The need for flexible light measuring instruments has increased with the growing use of non-incandescent and non-fluorescent light sources, such as LEDs, both in consumer appliances and in commercial environments. These light sources are generally unstable to temperature variations and ageing, so that their spectral properties (including colour point and colour rendering index) need to be monitored and continually adjusted to ensure an even quality of the emitted light. Furthermore, spectral properties measured as a function of the incidence direction of the light have turned out to be useful information when a pleasant and/or energy-optimal atmosphere is to be created.

Known instruments which measure both the angle of incidence and the wavelength of the received light are often diffraction-based, and therefore they are rather large and costly for lighting applications. In many cases the field of view is too restricted to meet the requirements in lighting technology. More sophisticated instruments may provide a satisfactory precision, but are, for reasons of their physical size and technical complexity, not well suited for lighting applications.

For instance, U.S. Pat. No. 4,625,108 discloses a hemispherical detector device, inside which optical fibres conduct light from the exterior surface of the device to optical sensors. The coverage angle of each optical fibre is restricted by means of a lens cap embedded in the body of the device. An evaluating circuit is adapted to determine the angle of incidence of the received optical radiation. Some additional fibre bundles are distributed among the optical fibres. Each fibre in such a bundle is led to a colour-filtered optical sensor, and using properly chosen filters it is possible to determine spectral properties of the light received in the direction of the bundle end. A minimal lens cap diameter is dictated by sensitivity requirements, a minimum number of fibres is dictated by precision requirements, hence the hemispherical portion of the device has a least possible radius.

It is an object of the present invention to provide a detector capable of measuring properties of light as a function of the angle of incidence at some reception point. Properties of light include, but are not limited to, intensity, colour point, colour rendering index, collimation, spectral distribution. Moreover, a detector which includes data processing means is also capable of providing information about related quantities. For instance, knowing the intensity of the light as a function of all incidence angles, the detector can determine the direction of the main light source in its field of view by a simple calculation.

It is a further object of the present invention to provide a detector with the above features that is small in size, can be fabricated in few steps from standard components, and the measurements of which still exhibit an acceptable accuracy for use in lighting applications.

Thus, in accordance with a first aspect of the invention, there is provided a detector for receiving light impinging at a reception point and for measuring, for a plurality of angles of incidence, at least one property of the light. The detector includes:
a plurality of light sensors, each of which is associated with an acceptance interval (which defines the angle of incidence which a light beam must have to reach the light sensor) and at least two acceptance intervals are different from one another; and
an optical conductor for conducting a light beam from the reception point to a particular light sensor, but only if the angle of incidence of the light beam belongs to the acceptance interval associated with the particular light sensor.

In one embodiment of the invention, the optical conductor comprises a refractive element and a collimator. The shape of the refractive element is such that, firstly, light beams which pass through the reception point are refracted in the acceptance direction of the collimator and, secondly, that light beams with separate angles of incidence will be conducted to separate light sensors. The refractive element may have a spherically curved surface. To reduce optical aberration, it may also have a non-spherically curved surface. A detector which determines an incidence angle with particularly high precision can be provided by using refractive elements with a conical shape.

In another embodiment of the invention, which provides an alternative to that comprising a refractive element, the optical conductor includes a reflective element, which is more suitable in applications where the angles of incidence tend to be large. When small angles of incidence are expected, the refractive element option is more compact. The shape of the reflective element has the same functional properties as the reflective element in the first embodiment. In still another embodiment of the invention, the optical conductor includes a plurality of optical fibres. By the refractive properties of the fibres and the material surrounding them, the fibres conduct light to the light sensors from different regions of space. Optical fibres are light, size-economical and shock-proof. Moreover, they are highly directive and can be used to define an exact field of view.

In accordance with a second aspect of the invention there is provided a method for measuring, for a plurality of angles of incidence, at least one property of light impinging at a reception point. The method includes:
receiving light;
conducting the received light via an optical conductor to a plurality of light sensors; and
measuring at least one property of the light at the light sensors,

The equipment used is so constructed that each light sensor is associated with an acceptance interval. At least two acceptance intervals are mutually different. A light beam is conducted to a particular light sensor only if the angle of incidence of the light beam belongs to the acceptance interval associated with the particular light sensor.

These and other aspects of the invention will be apparent from and further elucidated with reference to the embodiments described hereinafter.

The invention will now be described in more detail and with reference to the appended drawings, of which:

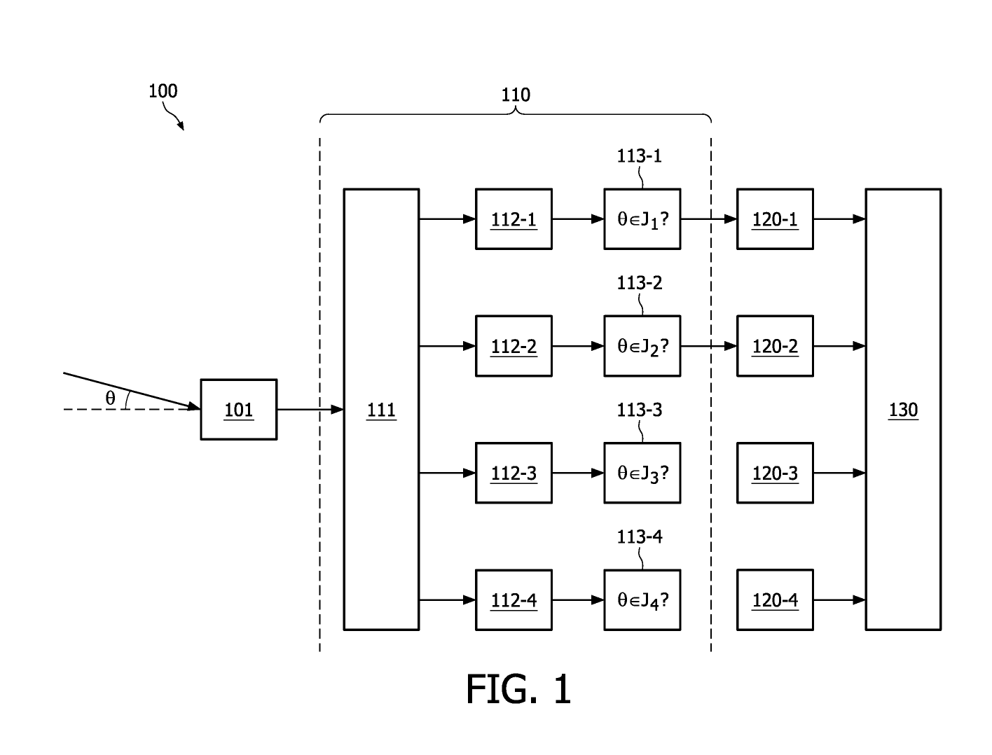

FIG. 1 is a block diagram which illustrates a principle of operation of a detector according to the invention;

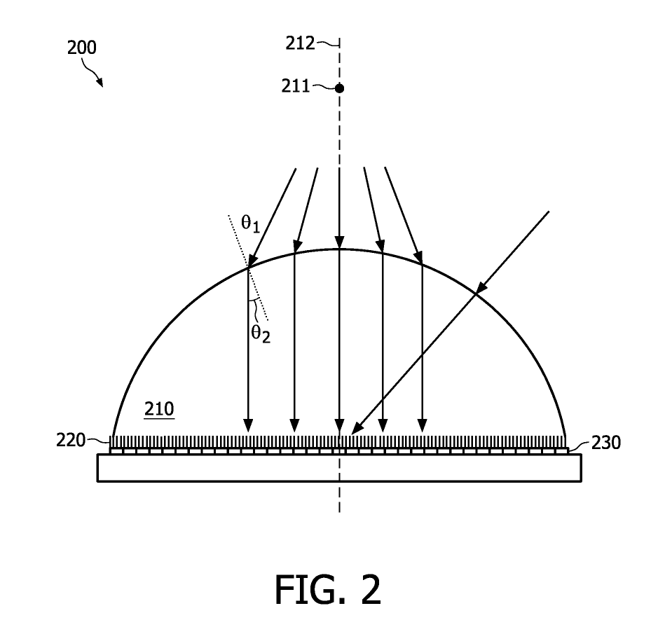

FIG. 2 is a cross-sectional view of a detector according to an embodiment of the invention, as seen in the plane defined by a light beam entering the detector, in which the light sensors are preceded by a spherical lens and a collimator;

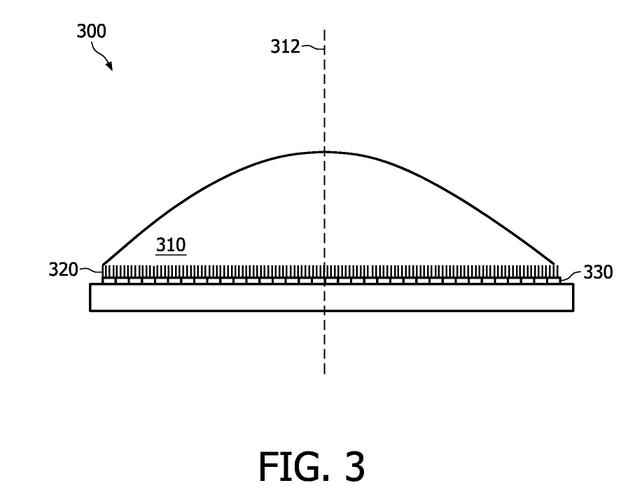

FIG. 3 is a cross-sectional view of a detector according to another embodiment the invention, as seen in the plane defined by a light beam entering the detector, in which the light sensors are preceded by a non-spherical refractive element and a collimator;

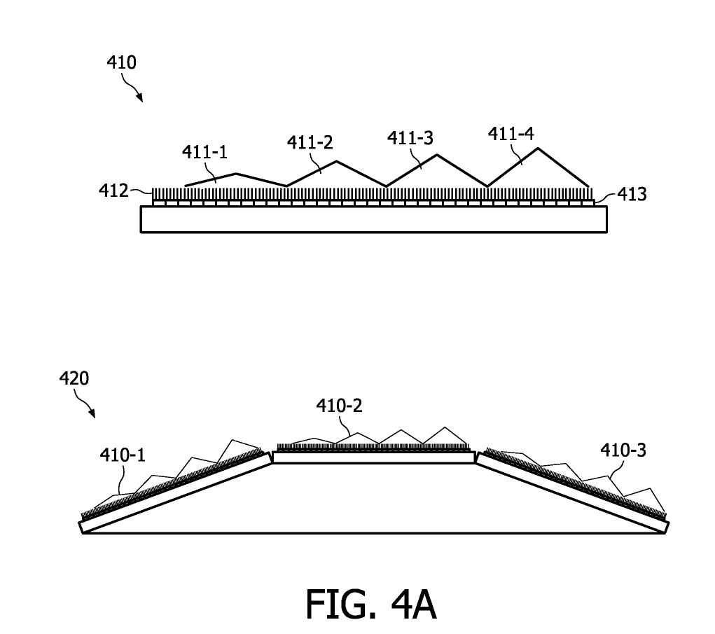

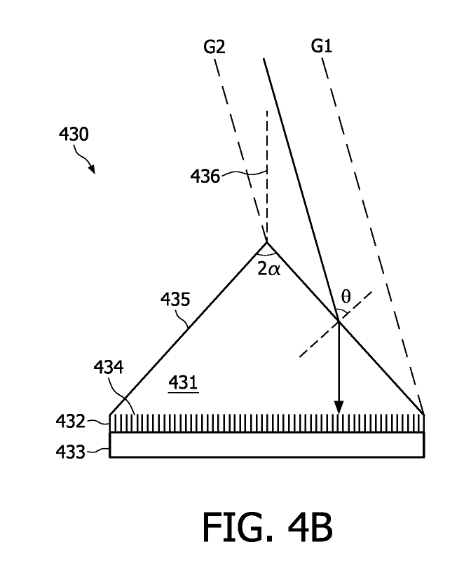

FIG. 4A is a cross-sectional view of a detector according to a further embodiment of the invention, in which the light sensors are preceded by conical refractive elements and a collimator, and also shows a side view of an alternative embodiment of this detector;

FIG. 4B shows the path of light beams entering one of the conical refractive elements shown in FIG. 4A;

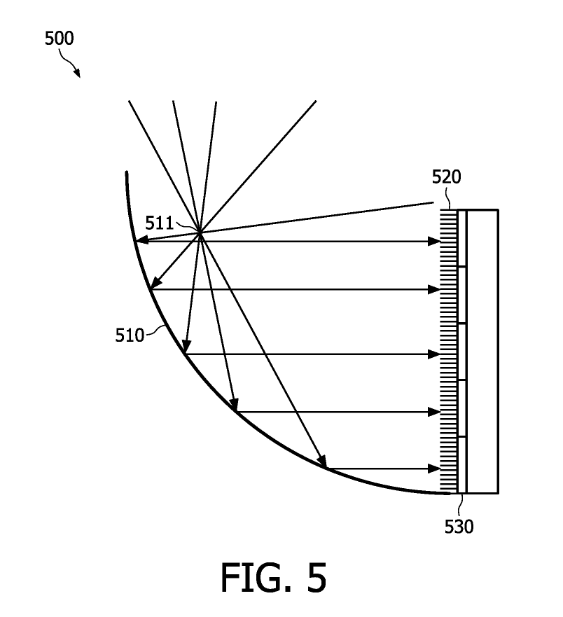

FIG. 5 is a side view of a detector according to yet another embodiment the invention in which the light sensors are preceded by a reflective element and a collimator;

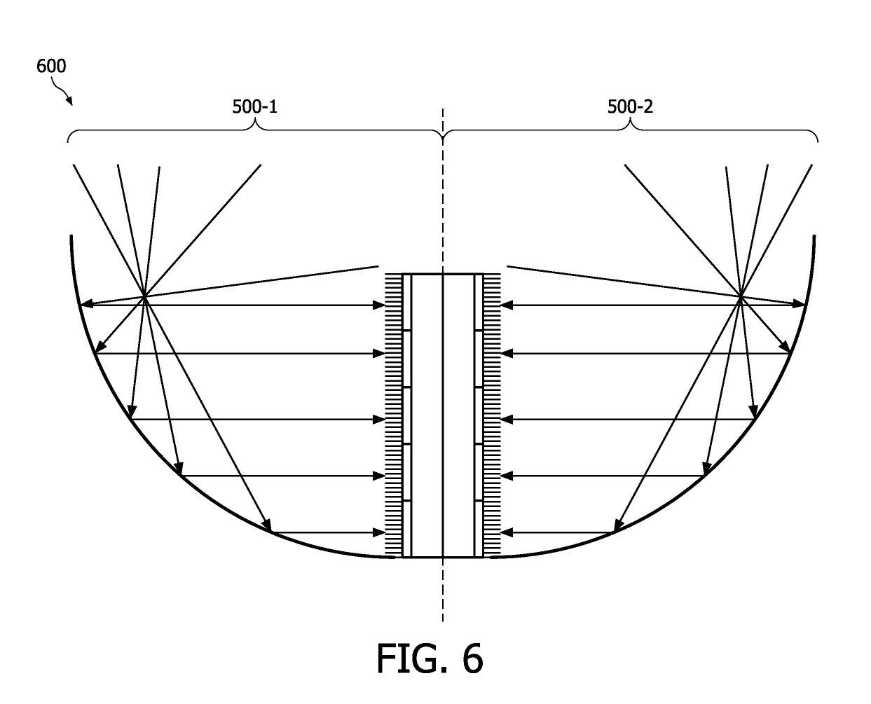

FIG. 6 is a side view of a detector according to an embodiment of the invention providing an alternative to that shown in FIG. 5;

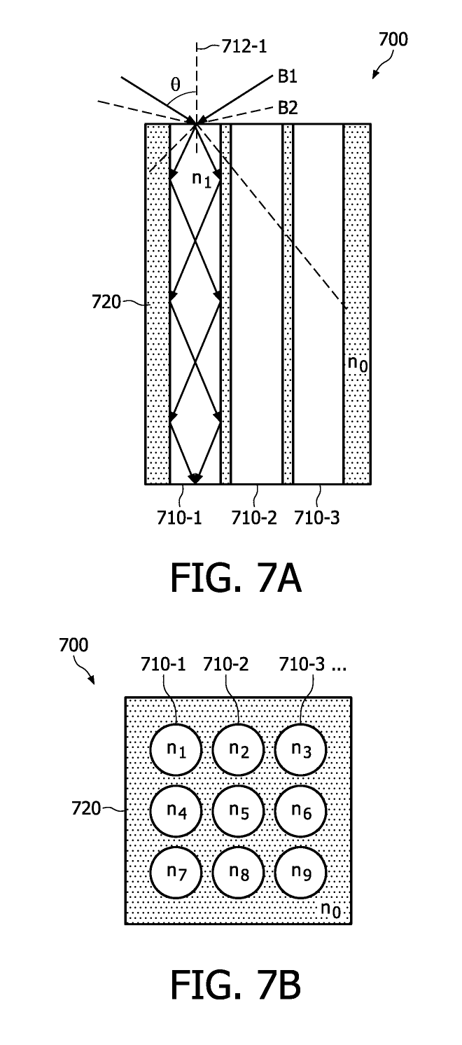

FIG. 7A is a cross-sectional view of a detector according to an embodiment of the invention, in which the light sensors are preceded by a bundle of parallel optical fibres, as seen in the plane through the centres of a row of fibres,

FIG. 7B is an end view of the detector of FIG. 7A, as seen from the end which is adapted to receive light; and

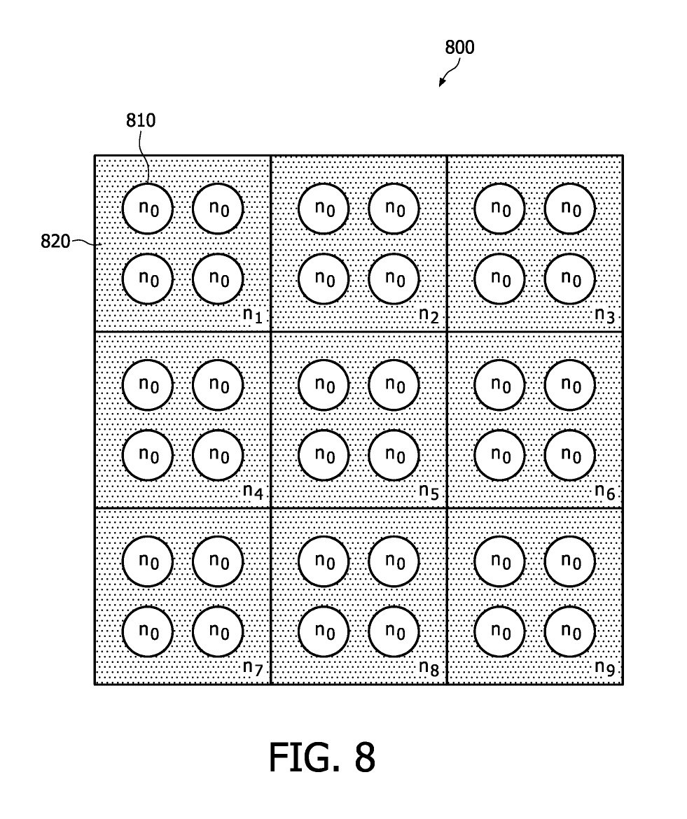

FIG. 8 is an end view of a detector according to an embodiment of the invention providing an alternative to that shown in FIGS. 7A and 7B.

Operation of a detector 100 according to an embodiment of the invention will initially be described. In the following, the term light will include any kind of electromagnetic radiation and light beam will mean a narrow projection of electromagnetic energy. The detector is assumed to include a reception point 101, which is a point or—for reasons of optical aberrations or constructional constraints—a region in space with a finite extent. The angle of incidence θ of a light beam is measured at the point where the light beam enters the reception point. The angle of incidence of a light beam may be defined with respect to an optical axis of a component of the detector, but may be defined with respect to a second reference direction as well, thereby yielding a two-component angle of incidence (θ₁, θ₂) consisting of, e.g., a polar and an azimuth angle. Finally, incidental use of identical variables (such as n₁, Jₖ etc.) in connection with different embodiments in no way asserts that these should have identical numerical values.

With reference to the block diagram of FIG. 1, light reaches the reception point 101 of the detector 100. For simplicity, the light consists of only one light beam and thus has one angle of incidence θ. The detector comprises a plurality of light sensors 120-1, 120-1, . . . , 120-n, which may be separate devices, subparts of an array of sensors or portions of an integrated multi-pixel light sensor, but in any case independently readable. By construction of the detector, each light sensor is associated with an acceptance interval Jₖ defining the angle of incidence which a light beam must have to reach the light sensor 120-k. The acceptance interval may be a union of intervals. The light is conducted to the light sensors by an angle-discriminating optical arrangement 110, which may functionally be considered as a device composed of three portions: one light beam splitter 111, a plurality of light conductors 112-1, 112-2, . . . , 112-n and a plurality of filters 113-1, 113-2, . . . , 113-n. The characteristics of the filter 113-k is that it lets a light beam pass only if the light beam has an angle of incidence θ in the acceptance interval Jₖ. FIG. 1 shows the illustrative case n=4, in which the received light beam has an angle of incidence, which lies in J₁ and J₂ but not in J₃ or J₄. Hence, only light sensors 120-1 and 120-2 are activated.

The signals from the light sensors 120-1, 120-2, . . . , 120-n are collected by a processing section 130. Possible outputs from the detector will now be exemplified. Firstly, all intervals from which non-zero light intensity is received can be calculated. Knowing which acceptance intervals J₁, J₂, . . . , Jₙ receive light, it is very easy to derive which intersections of two intervals receive light, which intersections of three intervals receive light etc., thereby providing refined information. In the n=4 example above, it is known that light is received in J₁ and J₂ but not in J₃ and J₄. As an immediate consequence, light is received in J₁∩J₂ but not in J₁∩J₃, J₁n∩₄, J₂∩J₃, J₂∩J₄, J₃∩J₄, J₁∩J₂∩J₃, J₁∩J₃∩J₄, J₂∩J₃∩J₄, J₁∩J₂∩J₄ or J₁∩J₂∩J₃∩J₄. Hence, by measuring in four intervals the detector can provide information about fifteen intervals. Generally, n light sensors will make information available about 2ⁿ−1 intersections of acceptance intervals, which can of course be expressed as 2ⁿ−1 non-overlapping subintervals, or even in terms of the central angle of incidence in each subinterval.

A second kind of possible output from the detector is the angle of incidence corresponding to the maximal received power. This is provided that the light sensors are appropriately calibrated—to compensate unequal interval sizes, variable sensor characteristics and the like—in order to be homogeneous in the sense that the calibrated intensities represented by the signals can be interpolated. Assuming calibration, the detector can also, thirdly, output an intensity map with respect to the angles of incidence. The resolution of the map is related to the number of different acceptance intervals used and their positions. The map may consist of steps of constant data levels, corresponding to intersections of acceptance intervals, but may also be generated by some kind of interpolation.

The light sensors may be colour sensitive or may be arranged in groups where they are preceded by different colour filters. The intensity and colour point measured by each sensor or each group of sensors can be represented by a triple of signals denoting intensities of three base colours. Assuming again that the sensors are calibrated in an appropriate way, so that interpolation can be performed, the detector can output, fourthly, a colour map with respect to the angles of incidence. Spectral measurements other than the colour point are indeed possible, for instance measurements of the colour rendering index.

Having set forth the principles of a detector according to the invention, the description will now address a number of preferred embodiments thereof. With reference to FIG. 2, the features will be described of a detector 200 according to an embodiment of the invention, in which the light sensors 230 are preceded by a spherical lens 210 and a collimator 220. The collimator 220 prevents light beams from reaching the light sensors 230 unless the light beams have a predetermined direction (within a tolerance), which will subsequently be referred to as the acceptance direction of the collimator 220. A collimator may for example consist of a light-absorbing slab perforated by a plurality of thin holes; the fineness of the holes determines the tolerance in this case. It is assumed for simplicity that the acceptance direction is the direction normal to the collimator 220 (although collimators with different acceptance directions are known in the art), which is the vertical direction on the drawing. Hence, only light beams normal to the collimator 220 will reach the light sensors 230 and be registered.

As is well known to the skilled person, the spherical lens 210 is a converging lens, which refracts light beams passing through the focal point 211 of the lens into beams parallel to the optical axis 212. Only such light beams will be transmitted by the collimator 220 and reach the light sensors 230 beyond the collimator 220. Hence, the focal point 211 is the reception point of the detector in accordance with this embodiment of the invention. Assuming that the medium that surrounds the lens is air, the focal point 211 is located on the optical axis 212 of the lens at an approximate distance of R/(n−1), where R is the radius of curvature of the curved surface of the lens 210 and n is the refractive index of the lens. A light beam reaching the focal point 211 at a larger angle of incidence will be conducted to light sensors 230 located further away from the optical centre of the lens 210. Hence, in this embodiment, the acceptance interval of a light sensor is a narrow interval, the width of which is determined by the tolerance of the collimator 220 and which may only overlap with those of adjacent light sensors.

FIG. 3 is a cross-sectional view of a detector 300 according to another embodiment of the invention, which provides an alternative to that shown in FIG. 2. In the detector 300, the light sensors 330 are preceded by a reflective element 310 with a non-spherical surface and a collimator 320. A reason for designing a detector with a non-spherical surface is that non-spherical lenses are less afflicted with optical aberration. Additionally, by avoiding steep angles of incidence, the light sensors on the fringe of the refractive element are utilised to a greater extent. The refractive element may or may not possess a focal point; in either case the reception point (which is possibly extended in space) is located on the optical axis 312.

The following shapes are also considered suitable for use as refractive elements in a detector according to the invention: a polyhedron, an element having at least one spherically curved surface and a toric lens.

FIG. 4A shows, firstly, of a detector 410 according to a further embodiment of the invention and, secondly, of a detector 420 composed of three detectors 410-1, 410-2, 410-3, each of which is identical to the detector 410. The light sensors 413 of the detector 410 are preceded by four conical refractive elements 411-1, 411-2, 411-3, 411-4 and a collimator 412. By the presence of the refractive elements 411, this embodiment resembles those shown in FIGS. 2 and 3. In the detector 420, the detectors have three different inclination angles with respect to the frame of the instrument. The use of an arrangement detectors 410, in which the light sensors 413 are preceded by different colour filters, is likewise envisaged. FIG. 4A is a cross-sectional view through the centres of the conical refractive elements 411.

With reference specifically to FIG. 4B, the optical function will now be described of a detector 430 comprising a single conical refractive element 431. FIG. 4B is a cross-sectional view, which shows a flat base 434 of the conical element 431 and a curved lateral surface 435. A line 436 corresponds to the symmetry axis of the conical element 431. It is assumed once more that the acceptance direction of the collimator is the normal direction. The light sensor 433 after the conical refractive element 431 and collimator 432 receives light beams reaching the conical refractive element in such a direction that they are refracted in a substantially vertical direction in the figure. The aperture angle of the cone is denoted by 2a and its relative refractive index by n; the drawing shows an example where n>1. The angle of refraction of a vertical light beam inside the cone is then π/2−α, and by Snell's law, its angle of incidence θ is given by equation 1:

sin θ=n cos α Equation 1

Hence, light is received from a cone shell of finite thickness having a family of generatrices consisting of those half lines which intersect the surface of the refractive element under an angle θ and intersect the axis of the conical refractive element. The outer extreme generatrix G1 and the inner extreme generatrix G2 have been drawn in FIG. 4B. The cone shell, from which light is received by the detector, is bounded by the two surfaces of revolution which are created by rotating G1 and G2 around the symmetry axis 436 of the conical refractive element.

A detector 500 in accordance with yet another embodiment of the invention will now be described with reference to FIG. 5. Light sensors 530 are preceded by a collimator 520, the acceptance direction of which is its normal direction, that is, the horizontal direction on the drawing. To the left of the collimator there is provided a reflective element 510. In this embodiment, the reflective element 510 has a parabolic shape. It is well known to the person skilled in the art that a parabolic mirror which is described by the equation y=ax² has a focal point located in x=0, y=¼a. All light beams passing through the focal point will be reflected off the mirror in a predetermined direction. In the detector 500 the reflective element 510 has been disposed in order that the predetermined direction is aligned with the acceptance direction of the collimator 520. Hence, the focal point of the parabola is a reception point 511 of the detector 500.

FIG. 6 shows an alternative embodiment of the invention, namely a detector 600 which is an arrangement of two detectors 500-1, 500-2, each being identical to the detector 500 shown in FIG. 5.

With reference to FIGS. 7A and 7B, a detector 700 in accordance with an embodiment of the invention will now be described. In the detector 700, each light sensor or subgroup of light sensors (not shown) is preceded by a transparent optical fibre 710. FIG. 7B is an end view of the detector 700 from the end which is adapted to receive light. The open ends of nine optical fibres 710-1, 710-2, 710-3 etc. are visible. As indicated, optical fibre 710-k has a refractive index of nₖ. The fibres 710 are surrounded by a cladding material 720 with a refractive index of n₀. FIG. 7A is a cross-sectional view through the central axes of optical fibres 710-1, 710-2 and 710-3. The drawing is not to scale: a real optical fibre is very thin compared to its length.

As is known to the skilled person, an optical fibre surrounded by a cladding material, having refractive indices n₁ and n₀, respectively, is characterised by its numerical aperture NA, which is defined by equation 2:

NA=nₑ sin θₘ=\sqrt{n₁²−n₀²} Equation 2

Here, nₑ is a refractive index of the medium from which light enters the optical fibre and θₘ is the maximal acceptance angle. Light beams entering the optical fibre at its centre under an angle less than or equal to θₘ, such as light beam B1 in FIG. 7A, undergo total reflection against the inner walls of the fibre, and will propagate without attenuation (apart from absorption in the fibre material). A light beam having a greater angle of incidence than θₘ, such as light beam B2 in FIG. 7A, will be partially reflected and partially transmitted past the fibre-cladding interface. Even though a small amount of energy may be lost (transmitted) at every reflection, the reflections typically occur so often that the amplitude of the light beam decreases significantly. An optical fibre therefore has an acceptance interval which is determined by the refractive properties of its constituent materials. Because of rotational symmetry, the acceptance intervals depend only of the angle of incidence θ, which is measured in the plane defined by the incident light beam and the optical axis of the fibre. Hence, the acceptance interval of an optical fibre is a cone around its optical axis.

FIG. 7A shows an optical axis 721-1 of the optical fibre 710-1. Light beam B1 lies in the acceptance interval, whereas light beam B2 does not. For clarity, no light beams propagating outside the plane of the drawing are included in FIG. 7A. The optical fibres 710 in the detector 700 have different refractive indices and, hence, different numerical apertures. Assuming nₑ=1 in equation 2, the maximal acceptance angle θₖ of fibre 710-k is given by equation 3:

sin θₖ=\sqrt{nₖ²−n₀²} Equation 3

It follows that the acceptance interval of the fibre is Jₖ=[0, θₖ]; recall that 0≦θ≦π/2 by definition. From measurements performed by the detector 700, it is therefore possible to extract information on light received in intervals [0,θ₁], [θ₁,θ₂], . . . , [θ₈,θ₉] (assuming that the refraction indices have been numbered in increasing order), which are geometrically half-infinite regions in space having as boundaries two cones with coinciding apexes. It is assumed that the top surface of the detector 700 is small enough that the respective optical axes 721-1, 722-2, etc. approximately coincide at an (imaginary) common optical axis. The reception point in the case of this embodiment is the intersection point of the common optical axis and the surface of the detector end which is adapted to receive light.

FIG. 8, finally, is an end view of a detector 800 according to an embodiment of the invention, which provides an alternative to the embodiment shown in FIGS. 7A and 7B. In the detector 800, all optical fibres 810 consist of the same material having a refractive index of n₀. In order to achieve different acceptance intervals, the fibres 810 are surrounded by different cladding materials 820, which have refractive indices of n₁, n₂, . . . , n₉. A group of four fibres is provided for each combination of a fibre material and a cladding material. The fibres in a group may conduct light to up to four differently colour-filtered light sensors, which will accordingly have different spectral properties but identical acceptance intervals.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality.

1. A detector for receiving light impinging at a reception point and for measuring, for a plurality of angles of incidence, at least one property of the light, said detector comprising:
a plurality of light sensors, each of which is associated with an acceptance interval defining the angle of incidence which a light beam must have to reach the light sensor, at least two acceptance intervals being different from one another; and
an optical conductor for conducting a light beam from the reception point to a particular light sensor only if the angle of incidence of the light beam belongs to the acceptance interval associated with the particular light sensor.

2. The detector of claim 1, wherein:
said plurality of light sensors only receive light beams parallel to a predetermined direction; and
said optical conductor comprises at least one optical element emitting a light beam parallel to the predetermined direction if the reception point lies substantially on the incident light beam.

3. The detector of claim 2, further comprising a collimator before each light sensor.

4. The detector of claim 2, wherein said at least one optical element is a refractive element.

5. The detector of claim 4, wherein said at least one refractive element (210; 310; 411; 431) is selected from the group consisting of:
a polyhedron,
a cone,
an element having at least one spherically curved surface,
a converging lens,
an non-spheric lens, and
a toric lens.

6. The detector of claim 2, wherein said optical conductor comprises at least one reflective element.

7. The detector of claim 6, wherein said at least one reflective element is a parabolic mirror.

8. The detector of claim 6, wherein said at least one reflective element includes a plurality of contiguous flat reflecting surfaces.

9. The detector of claim 1, wherein:
the optical conductor is a plurality of optical fibres, each having a first and second end, said first ends of said optical fibres being open and disposed substantially in a plane visible from the reception point, and a second end of each optical fibre being open towards at least one of said light sensors.

10. The detector of claim 9, wherein each light sensor is disposed for receiving light from the second end of at most one optical fibre.

11. The detector of claim 1, wherein at least one light sensor is preceded by a colour filter.

12. A method for measuring, for a plurality of angles of incidence, at least one property of light impinging at a reception point, comprising:
receiving light;
conducting the received light via an optical conductor to a plurality of light sensors; and
measuring at least one property of the light at the light sensors,
wherein:
each light sensor is associated with an acceptance interval, at least two acceptance intervals being different from one another; and
a light beam is conducted to a particular light sensor only if the angle of incidence of the light beam belongs to the acceptance interval associated with the particular light sensor.
